(19) United States
(12) Patent Application Publication
(10) Pub. No.: US 2015/0347950 A1
(43) Pub. Date: Dec. 3, 2015

(54) Agent Ranking

(71) Applicant: INTERNATIONAL BUSINESS MACHINES CORPORATION, Armonk, NY (US)

(72) Inventors: Praduemn K. Goyal, Holmdel, NJ (US); Hari S. Gupta, Jaipur (IN); Renuka R. Sindhgatta, Bangalore (IN)

(73) Assignee: INTERNATIONAL BUSINESS MACHINES CORPORATION, Armonk, NY (US)

(21) Appl. No.: 14/291,796

(22) Filed: May 30, 2014

(51) Int. Cl. G06Q 10/06

(52) U.S. Cl. CPC G06Q 10/06393

(57) ABSTRACT

A method and system for ranking agents is provided. The method includes retrieving historical assignment data describing past associations with agents and associated tickets. Groups of tickets are identified and historical attributes are extracted. Skills are associated with the agents and new attributes are associated with a new group of tickets. An absolute score for each agent with respect to a new group of tickets is generated and in response, an ordered list of the new group of tickets is generated.

### FIELD

The present invention relates generally to a method for ranking agents and in particular to a method and associated system for ranking agents based on expertise and a customer affinity.

### BACKGROUND

Selecting individuals for work assignment typically includes an inaccurate process with little flexibility. Assigning tasks may include a complicated process that may be time consuming and require a large amount of resources. Accordingly, there exists a need in the art to overcome at least some of the deficiencies and limitations described herein above.

### SUMMARY

A first aspect of the invention provides a method comprising: retrieving, by a computer processor of a computing system, historical assignment data describing past associations with agents and associated tickets; identifying, by said computer processor, groups of tickets of said associated tickets, each group of said tickets associated with a different agent of said agents;

extracting, by said computer processor, historical attributes from each said group of said tickets; associating, by said computer processor based on said groups of tickets and said historical attributes, a group of skills to each said different agent; identifying, by said computer processor, new attributes associated with a new group of tickets; generating, by said computer processor based on said historical attributes, each said group of skills, and said new attributes, an absolute score for each said different agent with respect to said new group of tickets; and generating, by said computer processor based on each said absolute score, an ordered list of said new group of tickets for each said different agent, wherein each said ordered list comprises a different order of said new group of tickets for each said different agent.

A second aspect of the invention provides a computing system comprising a computer processor coupled to a computer-readable memory unit, said memory unit comprising instructions that when executed by the computer processor implements a method comprising: retrieving, by said computer processor, historical assignment data describing past associations with agents and associated tickets; identifying, by said computer processor, groups of tickets of said associated tickets, each group of said tickets associated with a different agent of said agents; extracting, by said computer processor, historical attributes from each said group of said tickets; associating, by said computer processor based on said groups of tickets and said historical attributes, a group of skills to each said different agent; identifying, by said computer processor, new attributes associated with a new group of tickets; generating, by said computer processor based on said historical attributes, each said group of skills, and said new attributes, an absolute score for each said different agent with respect to said new group of tickets; and generating, by said computer processor based on each said absolute score, an ordered list of said new group of tickets for each said different agent, wherein each said ordered list comprises a different order of said new group of tickets for each said different agent.

A third aspect of the invention provides a computer program product, comprising a computer readable hardware storage device storing a computer readable program code, said computer readable program code comprising an algorithm that when executed by a computer processor of a computing system implements a method, said method comprising: retrieving, by said computer processor, historical assignment data describing past associations with agents and associated tickets; identifying, by said computer processor, groups of tickets of said associated tickets, each group of said tickets associated with a different agent of said agents; extracting, by said computer processor, historical attributes from each said group of said tickets; associating, by said computer processor based on said groups of tickets and said historical attributes, a group of skills to each said different agent; identifying, by said computer processor, new attributes associated with a new group of tickets; generating, by said computer processor based on said historical attributes, each said group of skills, and said new attributes, an absolute score for each said different agent with respect to said new group of tickets; and generating, by said computer processor based on each said absolute score, an ordered list of said new group of tickets for each said different agent, wherein each said ordered list comprises a different order of said new group of tickets for each said different agent.

The present invention advantageously provides a simple method and associated system capable of selecting individuals for work assignment.

### BRIEF DESCRIPTION OF THE DRAWINGS

FIG. 1 illustrates a system for enabling a process for performing optimized work assignment based on an expectation of performance, in accordance with embodiments of the present invention.

FIG. 2 illustrates an implementation example describing an algorithm for generating a relative ordered list for agents, in accordance with embodiments of the present invention

FIG. 3 illustrates an algorithm detailing a process flow enabled by the systems FIGS. 1 and for performing optimized work assignment based on an expectation of performance, in accordance with embodiments of the present invention.

FIG. 4 illustrates a system for enabling a ticket scoring and ordering process, in accordance with embodiments of the present invention.

FIG. 5 illustrates a computer system used by the systems of FIGS. 1 and 4 for enabling a process for performing optimized work assignment based on an expectation of performance, in accordance with embodiments of the present invention.

### DETAILED DESCRIPTION

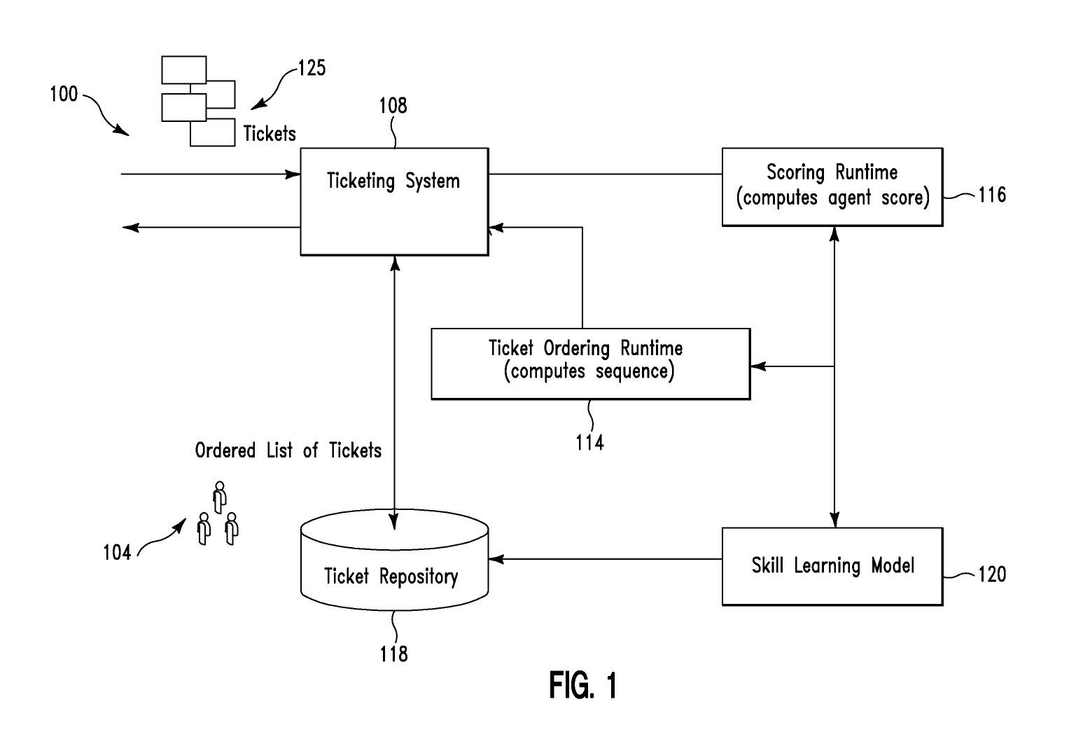

FIG. 1 illustrates a system 100 for enabling a process for performing optimized work assignment based on an expectation of performance, in accordance with embodiments of the present invention. System 100 performs a method for ordering a display of tickets in a queue for each agent so that each agent retrieves a correct ticket. The method includes:
1. Systematically evaluating skills required by agents with respect to resolving tickets.
2. Considering client factors and history of work performed by each agent.
3. Ranking skilled agents for resolving associated tickets.

System 100 evaluates expertise levels associated with agents 104 (for performing a task) based on: historical ticket resolutions (associated with tasks), client value factors and affinity scores, and scores (for each agent) relative to a new ticket arriving in system 100. A ticket is defined herein as a service request to address a technical glitch or issue associated with application or infrastructure maintenance. An agent is defined herein as a person belonging to a service provider organization responsible to review and resolve a ticket such that a customer no longer faces any technical issues. A number of displays at each position in a queue of agents are identified based on the expertise levels, a priority, a customer, and a target resolution time associated with a ticket. For example, if a priority ticket (comprising a priority level of 2) is presented to 10 agents at a first position (in the queue), the priority ticket may be retrieved within ten minutes. System 100 enables the following functions:
1. Evaluating a history of tasks (associated with jobs) performed by agents in the past based on a configurable look back in time.
2. Defining a custom score or ranking based on an expertise and resolution efficiency. The custom score or ranking may be generated based on a text analytics process performed on a history of ticket descriptions.
3. Considering client business value and risk in scoring agents.
4. Presenting an ordered list of tickets to an agent to ensure correct ticket retrieval via a linear program based optimization process.
5. Filtering tickets not associated with skills of an agent. A skill is defined herein as a knowledge or expertise required to resolve or solve a ticket.
6. Calibrating a model based on data associated with a ticket resolution history.

System 100 comprises a ticketing system 108, a scoring runtime module 110, a ticket ordering runtime module 114, a ticket repository 118, and a skill learning model module 120. Ticketing system 108 retrieves tickets 125 and associated assignment history. Incoming ticket attributes are received by scoring runtime module 110 and associated agent scores are calculated. Ticket ordering runtime module 114 generates a ticket sequence and associated tickets are stored within ticket repository 118. Skill learning model module 120 retrieves an assignment history from ticket repository 118 and generates a model associating agents with skills. System 100 generates an ordered list of tickets for each agent by:
1. Evaluating a historical ownership of tickets by agents
2. Identifying skill associated with agents relative to the new tickets.
3. Defining an absolute score for each agent with respect to a ticket.
4. Defining a relative score for each agent with respect to tickets
5. Providing an ordered list of tickets to each agent to ensure that they retrieve a most relevant ticket relative with respect to additional agents in an associated group of agents.

The aforementioned process is performed by:
1. Retrieving an assignment history with respect to agents by identifying all resolved tickets associated with an agent and extracting structured and unstructured information from the tickets.
2. Generating a skill model associating skills to an agent. Generating a skill model may include:
   A. Using ticket descriptions, resolution, and ticket attributes to associate skills to each agent.
   B. Using text analytics to determine skills and associate the skills to an agent.
   C. Identifying client base factors for evaluation.
3. Associating an absolute score of an agent to a ticket (i.e., for each new incoming ticket). The association process may include evaluating structured and unstructured attributes of a new ticket and providing an associated score to an agent based on a skill level.
4. Providing a relative ordered list of tickets to each agent based on skills of all agents with respect to a new ticket. A scoring mechanism may be used to determine a relative ordering of tickets for each agent such that an agent retrieves a most suitable ticket.

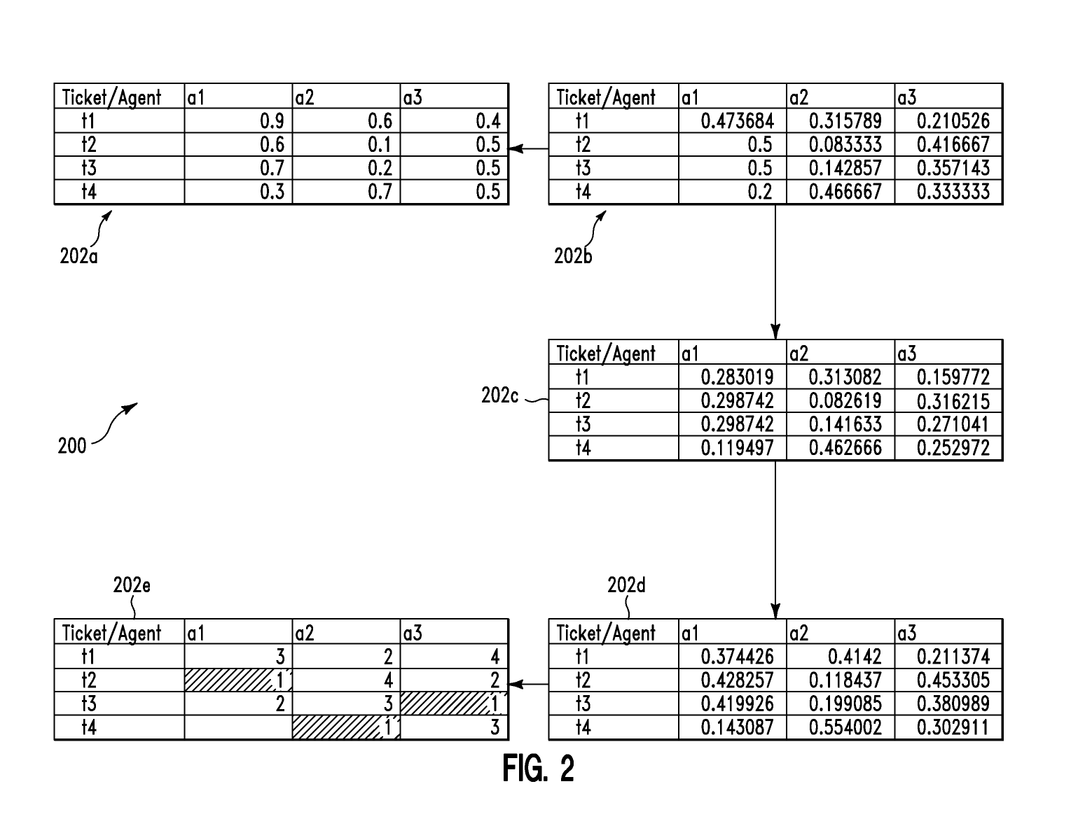

FIG. 2 illustrates an implementation example describing an algorithm 200 for generating a relative ordered list for agents, in accordance with embodiments of the present invention. A process for assimilating a customer affinity with customer business value factors is described with respect to a scoring model enhanced by including the following customer attributes:
1. An agent-to-customer specificity attribute comprising a ratio of a number of tickets resolved by an agent for a given customer with respect to a total number of tickets from the customer.
2. An agent-to-customer exclusivity attribute comprising a ratio of a number of tickets resolved by an agent for a given customer with respect to a total number of tickets resolved by the agent.
3. A relative customer business value attribute comprising a ration of a total lifetime revenue expected from a customer with respect to an average lifetime business revenue per customer. Another variation will consider relative period revenue for the customer.
4. A relative customer risk attribute comprising a ratio of expected probability of churn for a given customer with respect to an average probability of churn for all customers. An additional variation may consider a measure of predicted customer experience as measured by negative and positive events experienced historically (a number of tickets in a period).
5. Social business data attributes comprising factors in social media importance and social media sentiment data attributed to the customer.

Algorithm 200 for generating a relative ordered list of tickets (for agents) is described as follows:

A list of tickets 202a is provided and a score S′ᵢⱼ is calculated to normalize ranks for each ticket across rows of agents. The score S′ᵢⱼ is calculated using the following equation:

$${S}_{ij}^{′} = \frac{{S}_{ij}}{{\sum }_{i ∈ {S}_{A}} {S}_{ij}}$$

A resulting list of tickets 202b is generated and an score Ŝᵢⱼ is calculated to normalize each agent across all ticket columns. The score Ŝᵢⱼ is calculated using the following equation:

$${\hat{S}}_{ij} = \frac{{S}_{ij}^{′}}{{\sum }_{j ∈ {S}_{T}} {S}_{ij}^{′}}$$

A resulting list of tickets 202c is generated and score S′ᵢⱼ is calculated again to normalize ranks for each ticket across rows of agents. A resulting list of tickets 202d with respect to each agent is generated.

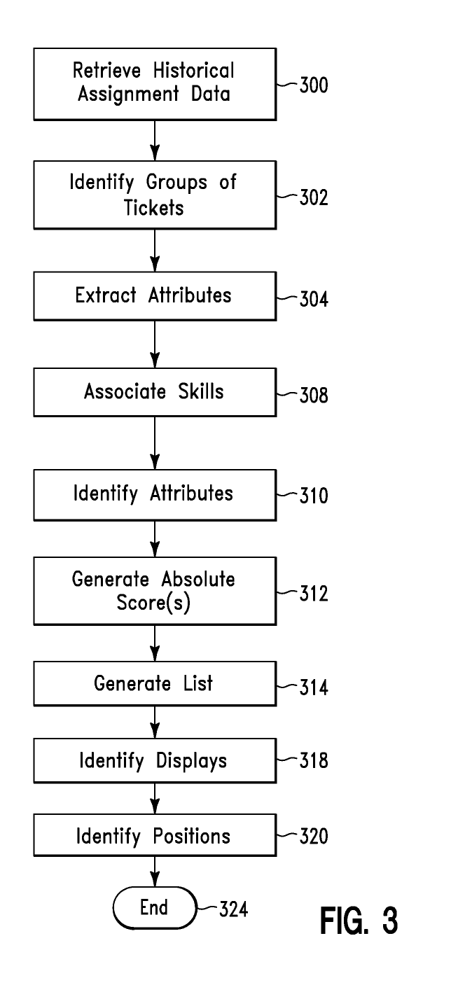

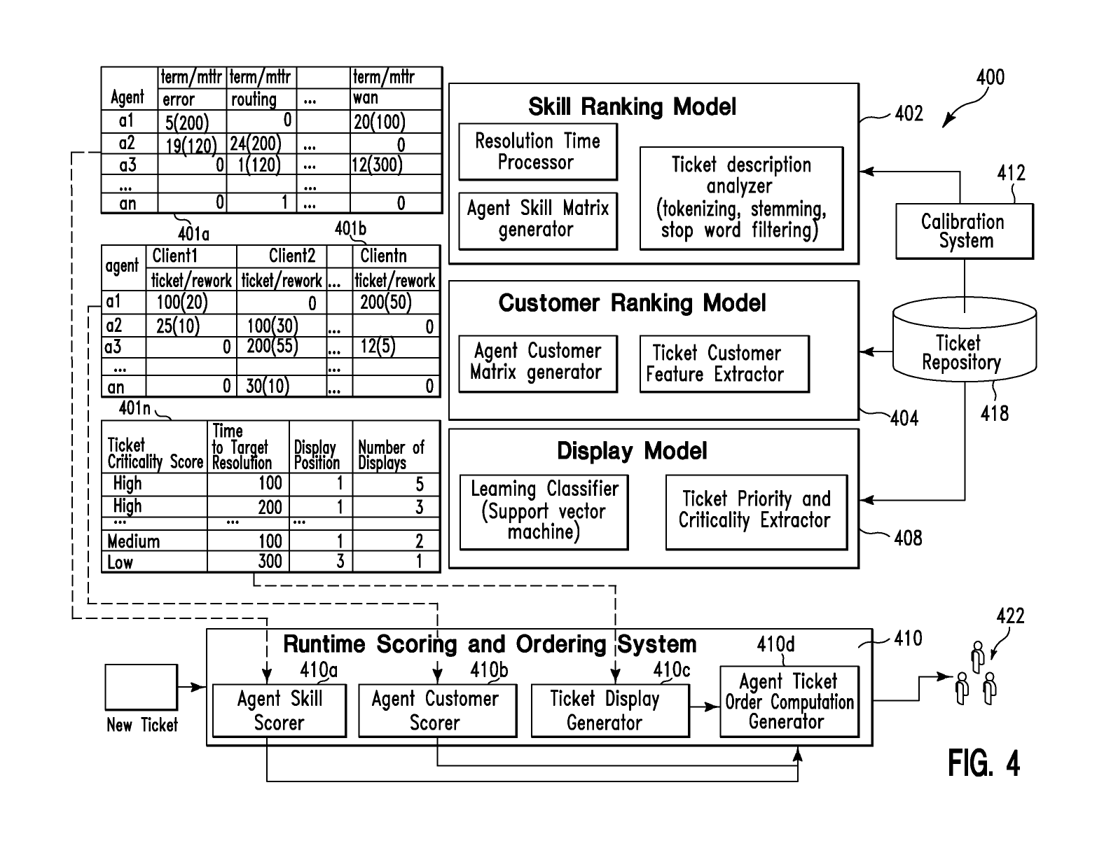

FIG. 3 illustrates an algorithm detailing a process flow enabled by system 100 of FIG. 1 (and system 400 of FIG. 4 as described, infra) for performing optimized work assignment based on an expectation of performance, in accordance with embodiments of the present invention. Each of the steps in the algorithm of FIG. 3 may be enabled and executed in any order by a computer processor executing computer code. In step 300, historical assignment data describing past associations with agents and associated tickets is retrieved. In step 302, groups of tickets of the associated tickets are identified. Each group of tickets is associated with a different agent of the agents. In step 304, historical attributes from each group of tickets are extracted. The historical attributes may comprise structured and unstructured attributes. The historical attributes may be extracted by:
1. Retrieving an assignment history for a specific look back time window.
2. Developing a model to associate an agent with associated skills from history the historical assignment data.
3. Associating a score with an agent for each incoming new ticket.
4. Suggesting an ordered list of tickets to retrieve based on an agent ticket score.

In step 308, a group of skills are associated with each different agent based on the groups of tickets and historical attributes. In step 310, new attributes associated with a new group of tickets are identified. In step 312, an absolute score for each different agent with respect to the new group of tickets is generated based on the historical attributes, each group of skills, and the new attributes. An absolute scoring process for agents with respect to tickets (i.e., based on skills and efficiency) is executed by calculating a score S_{T}(a) for an agent a with respect to a ticket T for each agent a based on a history of tickets resolved as follows:

$$\text{?}$$

$$\text{?} \text{indicates text missing or illegible when filed}$$

w(t) comprises a weight of the terms of a ticket Tₜ matching with terms in tickets resolved by an agent in a past time Tₐ. A weight for each term t for an agent is given by:
1. A term frequency for the agent comprising a ratio for a number of tickets resolved by the agent containing the term t with respect to a total number of tickets containing the term t.
2. A discriminative quality of the term t comprising a ratio of the total number of agents with respect to a number of agents having resolved tickets with term t.
3. A mean time to resolve comprising a ratio of a median MTTR of tickets containing the term t with respect to the a median MMTR of tickets containing term t resolved by the agent as follows:

$${w}_{t} ( a ) = \frac{{n}_{t} ( a )}{{N}_{t}} \times \frac{\vert A \vert}{{N}_{a} ( t )} \times \frac{mean ( {mttr}_{t} )}{mean ( {mttr}_{t} ( a ) )}$$

In step 314, an ordered list of the new group of tickets for each different agent is generated based on each absolute score. Each ordered list comprises a different order of the new group of tickets for each different agent. In step 318, a number of displays required at a given position for each ticket of the new group of tickets at a specified position in a queue is identified. The number of displays may be identified by:
1. Executing a controlled experiment with respect to a limited set of agents.
2. Displaying a ticket of a given priority and time to resolution at a given position i in N agents queue. The given position i comprises a time that a ticket resides in a queue before it is captured. The number N is varied and comprises a time spent in the queue.
3. Generating a learning/predictive model that identifies the number of displays required at a given position in the queue.

In step 320, a position for each ticket in each associated display for each of different agent is determined based on the number of displays and each absolute score for each different agent such that a ticket associated with an agent associated with an optimal score is presented on a display at a first display position. A position for each ticket may be determined by:
1. Identifying a number of displays N_{Dpj} required at a given position for a ticket j at position D. For example, T1 comprises a high priority ticket needing to be presented at a position 1 in the queue of 2 agents. N_{1T1}=2. A total number of displays for a ticket should be less than or equal to a number of agents.
2. A constraint based algorithm is used to compute a display count for each position for a ticket given a required display count thereby minimizing a number of slots remaining at each position for each ticket. Given a number of available display slots for a ticket at each position linear programming is used to determine if a ticket should be displayed at a given position to a given agent. An overall rank of agent at a given position is maximized.

The process is terminated in step 324.

FIG. 4 illustrates a system 400 for enabling a ticket scoring and ordering process, in accordance with embodiments of the present invention. System 400 comprises a skill ranking model module 402, a customer ranking model module 404, a display model module 408, a calibration system 412, a ticket repository 418, and a runtime scoring and ordering system 410. Skill ranking model module 402 is configured to extract resolved tickets from ticket repository 418. For each ticket, a ticket description is extracted and analyzed (e.g., tokenizes, stems, filter stop words, etc.). Skill ranking model module 402 develops a skill (term) and agent matrix comprising a median MTTR of an agent per ticket term. Customer ranking model module 404 is configured to extract resolved tickets resolved from ticket repository 418. For each agent, a set of customers (he/she has worked) is associated with a quality of work in terms of rework etc. Customer ranking model module 404 develops an agent and customer matrix. Display ranking model module 408 is configured to extract resolved tickets resolved from ticket repository 418. Customer ranking model module 404 evaluates time periods associated with agent ticket pickup times via inputs from experts. Additionally, customer ranking model module 404 builds a display ranking model comprising a number of displays at each position in an agent queue. Run time scoring and ordering system 410 is configured to evaluate new ticket s 401a . . . 401n being reported into system 400. Run time scoring and ordering system 410 an agent skill scorer 410a, an agent customer scorer 401b, a ticket display generator 410c, and an agent tick order computation program 410d. Agent skill scorer 410a is configured to compute a score for each agent with respect to a new ticket based on computations performed by skill ranking model module 402. Agent customer scorer 410b is configured to computes a score for each agent with respect to a new ticket based on computations performed by customer ranking model module 404. Ticket display generator 410c is configured to compute a number of displays required at each position based on ticket criticality and target time to resolution. Agent ticket order computation program 410d is configured to retrieve inputs from skill ranking model module 402, customer ranking model module 404, and display model module 408 and generate an ordered list of tickets for each agent. Calibration system 412 is configured to periodically collect tickets from ticket repository 418 and update a resulting model.

System 400 enables a method for obtaining a skill level of agents and providing an absolute score to agents based on historical ticket assignment and resolution history as follows:
1. Evaluating a historical assignment of tickets by:
   A. Considering a history of tickets resolved by an agent in the past.
   B. Extracting structured and unstructured information from the tickets and building an associated model.
2. Analyzing tickets to identify skills and client affinity by using text analytics to identify key tickets associated with an agent and a defined skill model.
3. Generating an absolute score to identify a skill of an agent with respect to a ticket.
   A. Evaluating a required skill with respect to a new ticket and a skill gained by an agent during a historical resolution.
   B. Evaluating a client affinity of an agent with respect to a new ticket.

System 400 enables a method for providing an ordered list of tickets for each agent such that each agent selects a most suitable ticket from the overall system as follows:
1. Given attributes of a ticket, a total number of displays is retrieved using historical analysis.
2. Based on a number of available agents, a number of displays available for each ticket at a given position is identified.
3. A number of displays available at each position for each ticket is presented to users 422 and a display position for the tickets with respect to each agent is identified.

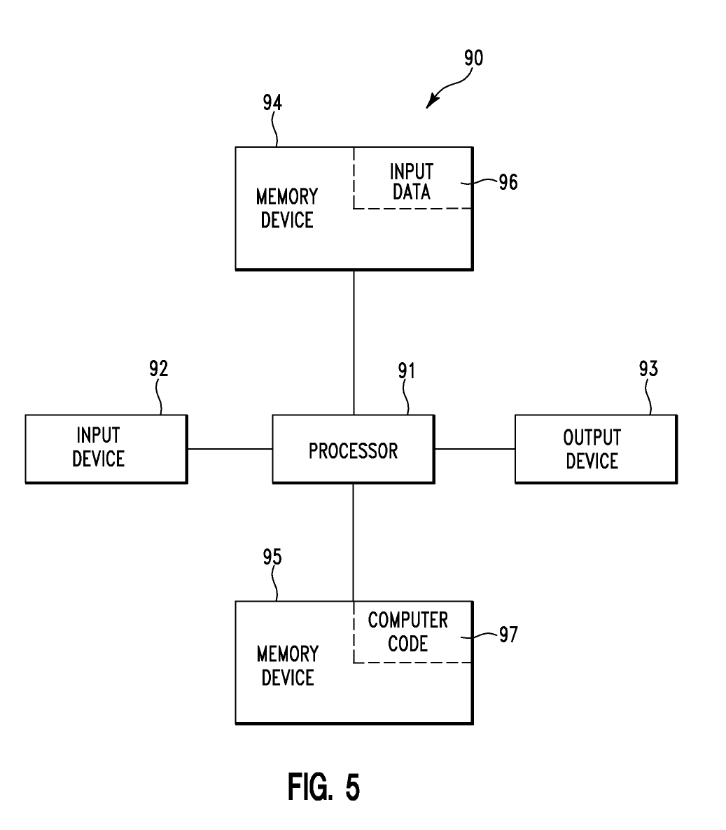

FIG. 5 illustrates a computer system 90 used by or comprised by the systems of FIGS. 1 and 4 for performing optimized work assignment based on an expectation of performance, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 5 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 3 and 4) for performing optimized work assignment based on an expectation of performance. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may include the algorithms of FIGS. 2 and 3 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

Still yet, any of the components of the present invention could be created, integrated, hosted, maintained, deployed, managed, serviced, etc. by a service supplier who offers to for perform optimized work assignment based on an expectation of performance. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for monitoring, measuring, and tracking costs and benefits associated with an IT infrastructure. In another embodiment, the invention provides a business method that performs the process steps of the invention on a subscription, advertising, and/or fee basis. That is, a service supplier, such as a Solution Integrator, could offer to for perform optimized work assignment based on an expectation of performance. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
retrieving, by a computer processor of a computing system, historical assignment data describing past associations with agents and associated tickets;
identifying, by said computer processor, groups of tickets of said associated tickets, each group of said tickets associated with a different agent of said agents;
extracting, by said computer processor, historical attributes from each said group of said tickets;
associating, by said computer processor based on said groups of tickets and said historical attributes, a group of skills to each said different agent;
identifying, by said computer processor, new attributes associated with a new group of tickets;
generating, by said computer processor based on said historical attributes, each said group of skills, and said new attributes, an absolute score for each said different agent with respect to said new group of tickets; and
generating, by said computer processor based on each said absolute score, an ordered list of said new group of tickets for each said different agent, wherein each said ordered list comprises a different order of said new group of tickets for each said different agent.

2. The method of claim 1, wherein said historical attributes and said new attributes comprise structured attributes and unstructured attributes.

3. The method of claim 1, wherein said historical attributes and said new attributes comprise attributes associated with a customer affinity.

4. The method of claim 1, further comprising:
executing, by said computer processor, a text analytics process with respect to said historical assignment data determine each said group of skills.

5. The method of claim 1, wherein said historical assignment data is associated with a specified historical time period, and wherein said extracting said historical attributes from each said group of said tickets comprises:
generating a model for associating agent skills from each said group of skills.

6. The method of claim 1, wherein each said absolute score is generated based on a history of resolved tickets of said associated tickets.

7. The method of claim 1, wherein said generating said ordered list comprises:
identifying a number of displays required at a given position for each ticket of said new group of tickets at a specified position in a queue; and
identifying if each said ticket will be displayed at each said given position.

8. The method of claim 7, further comprising:
determining based on said number of displays and each said absolute score for each said different agent, a position for each said ticket in each associated display for each of said different agent such that a ticket associated with an agent associated with an optimal score is presented on a display at a first display position.

9. The method of claim 1, further comprising:
providing at least one support service for at least one of creating, integrating, hosting, maintaining, and deploying computer-readable code in the computing system, said code being executed by the computer processor to implement: said retrieving, said identifying, said extracting, said associating, said identifying, said generating each said group of skills, and said generating said ordered list.

10. A computing system comprising a computer processor coupled to a computer-readable memory unit, said memory unit comprising instructions that when executed by the computer processor implements a method comprising:
retrieving, by said computer processor, historical assignment data describing past associations with agents and associated tickets;
identifying, by said computer processor, groups of tickets of said associated tickets, each group of said tickets associated with a different agent of said agents;
extracting, by said computer processor, historical attributes from each said group of said tickets;
associating, by said computer processor based on said groups of tickets and said historical attributes, a group of skills to each said different agent;
identifying, by said computer processor, new attributes associated with a new group of tickets;
generating, by said computer processor based on said historical attributes, each said group of skills, and said new attributes, an absolute score for each said different agent with respect to said new group of tickets; and
generating, by said computer processor based on each said absolute score, an ordered list of said new group of tickets for each said different agent, wherein each said ordered list comprises a different order of said new group of tickets for each said different agent.

11. The computing system of claim 10, wherein said historical attributes and said new attributes comprise structured attributes and unstructured attributes.

12. The computing system of claim 10, wherein said historical attributes and said new attributes comprise attributes associated with a customer affinity.

13. The computing system of claim 10, wherein said method further comprises:
executing, by said computer processor, a text analytics process with respect to said historical assignment data determine each said group of skills.

14. The computing system of claim 10, wherein said historical assignment data is associated with a specified historical time period, and wherein said extracting said historical attributes from each said group of said tickets comprises:
generating a model for associating agent skills from each said group of skills.

15. The computing system of claim 10, wherein each said absolute score is generated based on a history of resolved tickets of said associated tickets.

16. The computing system of claim 10, wherein said generating said ordered list comprises:
identifying a number of displays required at a given position for each ticket of said new group of tickets at a specified position in a queue; and
identifying if each said ticket will be displayed at each said given position.

17. The computing system of claim 16, wherein said method further comprises:
determining based on said number of displays and each said absolute score for each said different agent, a position for each said ticket in each associated display for each of said different agent such that a ticket associated with an agent associated with an optimal score is presented on a display at a first display position.

18. A computer program product, comprising a computer readable hardware storage device storing a computer readable program code, said computer readable program code comprising an algorithm that when executed by a computer processor of a computing system implements a method, said method comprising:
retrieving, by said computer processor, historical assignment data describing past associations with agents and associated tickets;
identifying, by said computer processor, groups of tickets of said associated tickets, each group of said tickets associated with a different agent of said agents;
extracting, by said computer processor, historical attributes from each said group of said tickets;
associating, by said computer processor based on said groups of tickets and said historical attributes, a group of skills to each said different agent;
identifying, by said computer processor, new attributes associated with a new group of tickets;
generating, by said computer processor based on said historical attributes, each said group of skills, and said new attributes, an absolute score for each said different agent with respect to said new group of tickets; and
generating, by said computer processor based on each said absolute score, an ordered list of said new group of tickets for each said different agent, wherein each said ordered list comprises a different order of said new group of tickets for each said different agent.

19. The computer program product of claim 18, wherein said historical attributes and said new attributes comprise structured attributes and unstructured attributes.

20. The computer program product of claim 18, wherein said historical attributes and said new attributes comprise attributes associated with a customer affinity.
